(19) United States
(12) Patent Application Publication
(10) Pub. No.: US 2026/0312987 A1
(43) Pub. Date: Oct. 8, 2026

(54) METHOD AND APPARATUS FOR PROACTIVLY PROHIBITING NETWORK ROUTE HIJACKING

(71) Applicant: VERIZON PATENT AND LICENSING INC., Basking Ridge, NJ (US)

(72) Inventors: Manju THAMPY, Chennai (IN); Sanjay Ravi VYAS, Hyderabad (IN); Saranya KRISHNASWAMY, Chennai (IN); Vasu SHARMA, Hyderabad (IN); Muhammad USMAN, Plant City, FL (US)

(73) Assignee: VERIZON PATENT AND LICENSING INC., Basking Ridge, NJ (US)

(21) Appl. No.: 19/169,435

(22) Filed: Apr. 3, 2025

(51) Int. Cl. H04L 9/40

(52) U.S. Cl. CPC H04L 63/1466; H04L 63/1416

(57) ABSTRACT

Techniques for automatically and proactively prohibiting network route hijacking are disclosed. In one embodiment, a computerized method performed by a computing device is disclosed comprising obtaining subnet information, the subnet information comprising subnet ownership and operational status information for a subnet, generating a set of features for the subnet based on an analysis of the subnet's ownership and operational status information, making at least one route hijack prohibition action determination using the feature set, and causing at least one route hijack prohibition action to be taken in accordance with the determination.

### BACKGROUND INFORMATION

In modern networks, network routes may be hijacked by attackers to reroute network traffic using routing announcements that fraudulently identify the attacker as the owner. For example, a network entity can make an announcement identifying IP addresses that are neither owned by nor controlled by the entity. Unless and until it is caught, the announcement can be spread—i.e., be added to routing tables used by routers to route traffic to the network entity—and then used to reroute traffic to the route hijacker.

### BRIEF DESCRIPTION OF THE DRAWINGS

FIG. 1 provides an example illustrating components of a route protection engine used to identify, prohibit, eliminate, etc. route hijacking in accordance with embodiments of the present disclosure;

FIG. 2 provides an example of a schematic diagram illustrating feature determination of module 106 and action determination of module 108 in accordance with one or more disclosed embodiments;

FIG. 3 provides an exemplary illustration of feature set examples for use in accordance with one or more embodiments of the present disclosure;

FIG. 4 provides an exemplary example in which a Route Origin Authorization (ROA) created in accordance with disclosed embodiments can be used to prohibit network route hijacking;

FIG. 5 provides a network route hijacking prohibition process flow in accordance with one or more embodiments of the present disclosure; and

FIG. 6 provides a block diagram illustrating a computing device showing an example of client or server device used in accordance with one or more embodiments of the present disclosure.

### DETAILED DESCRIPTION OF EXAMPLE EMBODIMENTS

Improved techniques for automatically and proactively prohibiting network route hijacking are disclosed. Embodiments of the present disclosure can use real-time subnet discovery, proactive vulnerability prediction, and comprehensive security posture assessment to ensure network security and integrity. While embodiments of the present disclosure are discussed in connection with subnets and subnet blocks, or the Internet Protocol (IP) addresses assigned to subnets, it should be apparent that disclosed embodiments can be used in connection with any grouping of IP addresses indicative of a route for routing network traffic.

In accordance with one or more embodiments, subnets can be identified along with information about each subnet, such as operational status and ownership information. A subnet and its operational status can be determined using one or more network subnet scanning tools including, without limitation, a network connectivity tool, such as ping, fping, etc. In accordance with one or more embodiments, a subnet's operational status information can include information indicating whether the subnet is a routable subnet (e.g., active and reachable), whether the subnet exists in any routing table, whether any IP addresses from a subnet's subnet IP address block are unused, etc. Ownership information can include information obtained from Regional Internet Registries (RIRs), geofeed information obtained from the geofeeds provided by network entities, such as and without limitation, Internet Service Providers (ISPs), telecommunications network service providers, etc., and subnet inventory information provided by one or more network entities.

In accordance with one or more embodiments, the operational status and ownership information can be used to proactively identify and address route hijacking threats. Embodiments of the present disclosure can use the operational status and ownership information to automatically generate a Route Origin Authorization (ROA) for a subnet block requiring protection, trigger route invalidation requests to eliminate illegitimate route designations, generate reports detailing identified vulnerabilities, generated ROAs and route invalidation requests, etc.

An autonomous system (AS) can be a large network or group of networks managed by a single entity. RIRs distribute IP addresses to entities having ASes, such as ISPs, telecommunications network service providers, and other entities. A RIR can assign an autonomous system number (ASN) to each AS registered with the RIR, which can be used when making routing announcements. A routing announcement can be made by an AS using a routing protocol, such as Border Gateway Protocol (BCP), and can include information identifying the IP addresses controlled by the AS and information identifying the other networks connected to the announcing network. The routing information can be used to route network traffic from a source IP address to a destination IP address. A routing announcement can identify a subnetwork, or subnet, of IP addresses.

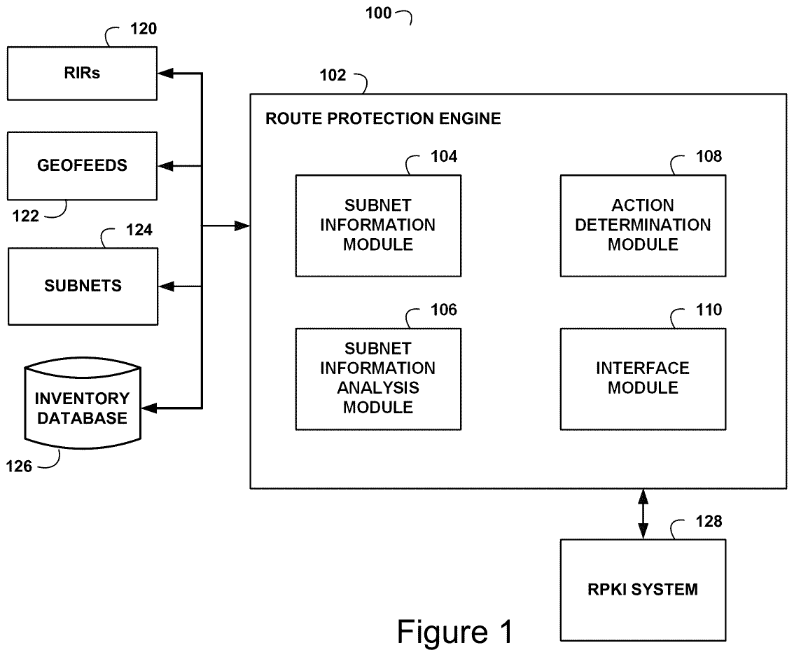

FIG. 1 provides an example illustrating components of a route protection engine used to identify, prohibit, eliminate, etc. route hijacking in accordance with embodiments of the present disclosure. In example 100, route protection engine 102 comprises subnet information module 104, subnet information analysis module 106, action determination module 108 and interface module 110.

Subnet information module 104 can obtain subnet block ownership information and subnet operational status information. RIRs 120 have the exclusive responsibility to distribute IP addresses to network entities requiring them. Module 104 can obtain a comprehensive inventory of all IP addresses that have been assigned to each AS of a network entity. The information obtained from RIRs 120 can be used to identify the subnet blocks owned by each AS. Module 104 can obtain geofeed 122. A geofeed is commonly published by a network entity—e.g., as a structured data file. The geofeed provides a correspondence, or mapping, between Internet Protocol (IP) address ranges and their associated geographical locations. The geofeed mapping information can be used to identify subnets and corresponding subnet block owned by a network entity.

A network entity can maintain inventory database 126, which can include information indicating the network entity's subnets and corresponding subnet blocks. Module 104 can query inventory database 126 to obtain information identifying the network entity's subnets and corresponding subnet blocks.

Module 104 can determine the operational status of the subnets identified from the information obtained from RIRs 120, geofeeds 122 and inventory database 126. By way of a non-limiting example, module 104 can use one or more network scanning tools to determination a subnet's operational status. By way of a non-limiting example, module 104 can conduct a ping test using a ping tool, such as fping, to identify, or verify, the operational status of each subnet. The ping test can be used to determine whether or not IP addresses of the subnet's IP address block are reachable and/or inactive.

In accordance with one or more embodiments, subnets that respond positively to these pings can be considered potential candidates for protection against hijacking threats. As is discussed in more detail below, a subnet that is active and reachable can be identified as a candidate for deployment of an ROA. An ROA includes information identifying the ASN (Asynchronous System Number) of the legitimate owner of a subnet and the block of IP addresses associated with the subnet. In accordance with one or more disclosed embodiments, a subnet can be identified as a candidate for an ROA, which can then be deployed to ensure that the legitimate owner of the subnet is the only entity that is authorized to originate a route in connection with the subnet and the subnet's IP address block.

In accordance with one or more embodiments, module 104 can provide a list of subnets as well as ownership and operational status information for each subnet from the list to subnet information analysis module 106. Module 106 can analyze the ownership and operational status information for each respective subnet in the list and generate a set of features, which can be used by action determination module 108 to determine an action to take in connection with the respective subnet given the subnet's determined features. By way of some non-limiting examples of actions, module 108 can determine to invalidate an existing route, invalidate an existing ROA, create an ROA, update subnet information in a network entity's inventory database, identify one or more recommended actions, etc.

As is described in more detail below, in accordance with one or more disclosed embodiments, module 108 can be a machine model trained to identify an action to take in connection with a subnet given a set of features determined for the subnet by module 106.

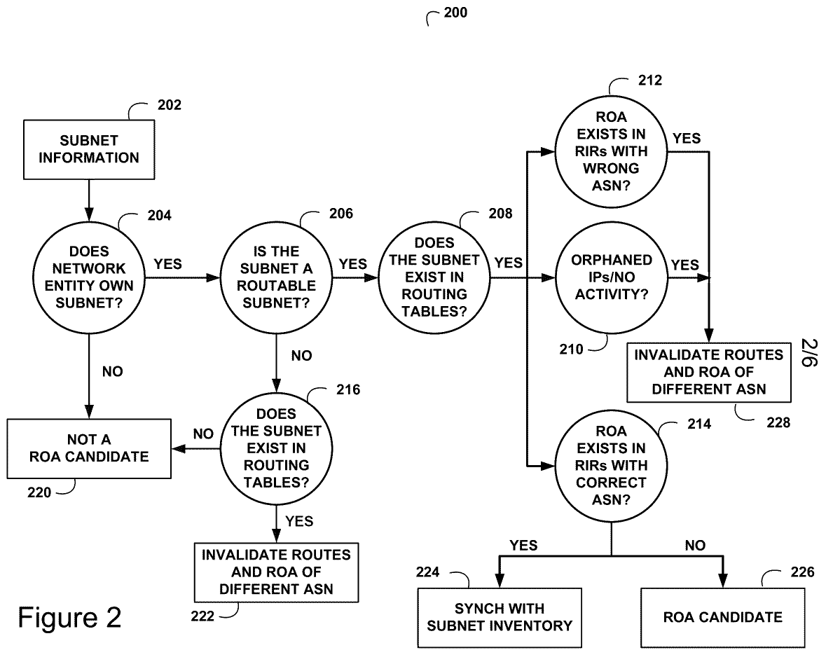

FIG. 2 provides an example of a schematic diagram illustrating feature determination of module 106 and action determination of module 108 in accordance with one or more disclosed embodiments. In example 200, elements 204, 206, 208, 210, 212, 214 and 216 can be performed by module 106 and elements 220, 222, 224, 226 and 228 can be performed by module 108. By way of a non-limiting example, module 106 can perform elements 204, 206, 208, 210, 212, 214 and 216 using a subnet's ownership and operational status information, e.g., subnet information 202, and generate a set of features for the subnet. Module 108 can use elements 220, 222, 224, 226 and 228 to determine an appropriate action in accordance with the subnet's feature set.

Although, modules 106 and 108 and the elements shown in example 200 are described in connection with one network entity, it should be apparent that modules 106 and 108 and the elements used by these modules can be used in connection with any number of network entities. A network entity can use engine 102 to proactively assess and act on hijacking threats associated with the subnets owned by the network entity. By way of a further non-limiting example, a RIR or other organization can use engine 102 in connection with the network entities within the region.

As shown in example 200, subnet information 202, which can include ownership and operational status information for a respective subnet identified by module 104, in input to element 204. At element 204, module 106 can use the ownership information in the subnet information 202 to make a determination whether or not the network entity owns the subnet and set at least one ownership feature in the subnet's feature set based on the determination.

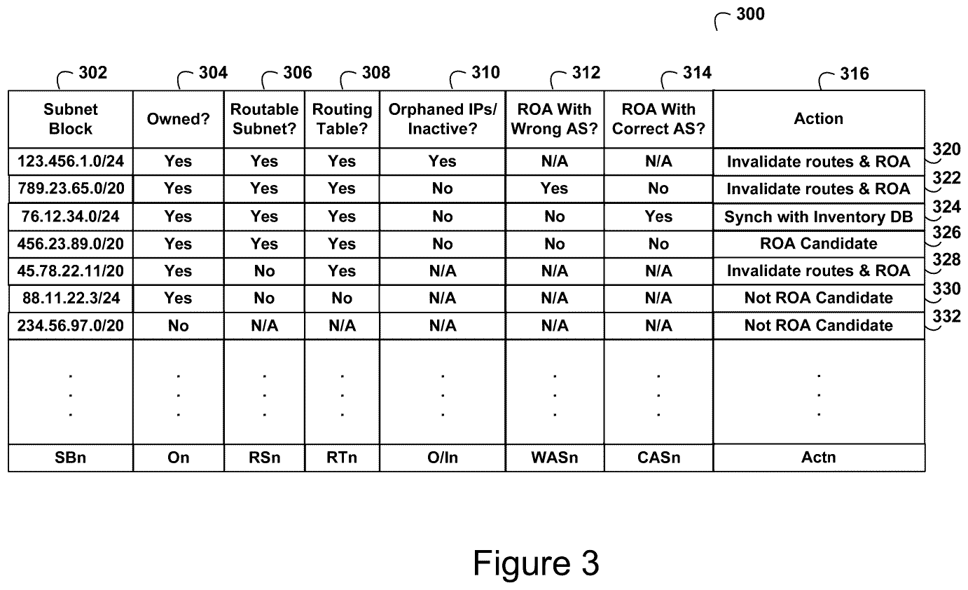

FIG. 3 provides an exemplary illustration of feature set examples for use in accordance with one or more embodiments of the present disclosure. It should be apparent that the feature set shown in example 300 can comprise additional, fewer and/or different features. In addition, it should be apparent that the actions shown in example 300 can comprise additional, fewer and/or different actions.

In example 300, column 304, which corresponds to an ownership feature, can be set by module 108 based on its determination made at element 204 using subnet information 202 whether the subnet is owned by the network entity. Column 302, which corresponds to a subnet block feature, can be used to identify the subnet block associated with a given subnet being processed by engine 102.

Referring again to FIG. 2, if module 106 determines, at element 204, that the subnet is not owned by the network entity, module 106 can set an ownership feature, at column 304, for the subnet to “No” and the remaining features to “N/A” for the subnet. Row 332 illustrates values of features of a feature set in this case.

If module 106 determines, at element 204, that the subnet is owned by the network entity, module 106 can make a determination, at element 206, whether or not the subnet is a routable subnet. Subnet information 202 can include information indicating whether or not the subnet is a routable subnet. By way of a non-limiting example, module 104 can determine whether the subnet is a routable subnet using one or more network scanning tools. As discussed herein, module 104 can include this information in the subnet information 202, as part of the operational status information for the subnet, in accordance with information from subnets 124.

In a case that module 106 makes a determination, at element 206, that the subnet is not a routable subnet, module 106 can make a determination, at element 216, whether the unrouteable subnet exists in one or more routing tables. Module 106 can use operational information included in subnet information 202 to make the determination at element 216. In a case that the module 106 determines, at element 216, that the unrouteable subnet does not exist in routing table(s), module 106 can generate a feature set such as that shown in row 330, of FIG. 3, which has a “Yes” in column 304 indicating that the subnet is owned by the network entity, a “No” in column 306 indicating that the subnet is not a routable subnet, a “No” in column 308 indicating that the subnet is not in a routing table, and a value (e.g., “N/A”) in columns 310, 312 and 314 indicating that the corresponding features are not applicable in this case.

As shown in example 300, in a case that the module 106 determines, at element 216, that an unrouteable subnet does exist in a routing table, module 106 can generate a feature set such as that shown in row 328, of FIG. 3, which has a “Yes” in column 304 indicating that the subnet is owned by the network entity, a “No” in column 306 indicating that the subnet is not a routable subnet, a “Yes” in column 308 indicating that the subnet is in at least one routing table, and a value (e.g., “N/A”) in columns 310, 312 and 314 indicating that the corresponding features are not applicable in this case.

In a case that module 106 determines, at element 206, that the subnet is a routable subnet, module 106 can use element 208 to make a determination whether or not the routable subnet exists in a routing table. If module 106 determines, at element 208, that the routable subnet exists in one or more routing tables, module 106 can proceed to determine the values of the features of the subnet's feature set to columns 310, 312 and 314 using elements 210, 212 and 214.

Using element 210, module 106 can use the operational status information from subnet information 202 to determine whether the subnet, which has been determined to be a routable subnet that exists in at least one routing table, is inactive or has any orphaned, or unused, IP addresses in its subnet IP address block. If so, module 106 can generate a feature set such as that shown in row 320, of FIG. 3, which has a “Yes” in column 304 indicating that the subnet is owned by the network entity, a “Yes” in column 306 indicating that the subnet is a routable subnet, a “Yes” in column 308 indicating that the subnet is in at least one routing table, a “Yes” in column 310 indicating that the subnet is inactive or has orphaned, or unused, IP addresses in its subnet IP address block, and a value (e.g., “N/A”) in columns 312 and 314 indicating that the corresponding features are not applicable in this case.

Using element 212, module 106 can use the subnet information 202 to determine whether the subnet, which has been determined to be a routable subnet that exists in at least one routing table, has an existing ROA with a wrong ASN. That is, a ROA that exists in one or more of the RIRs that uses an identification, or ASN, identifying an AS other than one of the network entity's ASes. If so, module 106 can generate a feature set such as that shown in row 322, of FIG. 3, which has a “Yes” in column 304 indicating that the subnet is owned by the network entity, a “Yes” in column 306 indicating that the subnet is a routable subnet, a “Yes” in column 308 indicating that the subnet is in at least one routing table, a “No” in column 310 indicating that the subnet is not inactive and does not have any orphaned, or unused, IP addresses in its subnet IP address block, a “Yes” in column 312 indicating that a ROA exists with an incorrect ASN, and a “No” column 314 indicating that the correct ASN is not specified in an existing ROA.

Using element 214, module 106 can use the subnet information 202 to determine whether the subnet, which has been determined to be a routable subnet that exists in at least one routing table, has an existing ROA with a correct ASN. That is, module 106 can make a determination whether or not a ROA exists that correctly identifies the ASN of an AS that is one of the network entity's ASes. If module 106 determines that there is no ROA that specifies the correct ASN of an AS owned by the network entity, module 106 can generate a feature data set such as that shown in row 326, of FIG. 3, which has a “Yes” in column 304 indicating that the subnet is owned by the network entity, a “Yes” in column 306 indicating that the subnet is a routable subnet, a “Yes” in column 308 indicating that the subnet is in at least one routing table, a “No” in column 310 indicating that the subnet is inactive or has orphaned, or unused, IP addresses in its subnet IP address block, a value of “No” in column 312 indicating that there is no ROA using an incorrect ASN, and a “No” in column 314 indicating that the correct ASN is not specified in an existing ROA.

In a case that module 106 determines, using element 214, that the subnet, which has been determined to be a routable subnet that exists in at least one routing table, has an existing ROA with a correct ASN, module 106 can generate a feature set such as that shown in row 324, of FIG. 3, which has a “Yes” in column 304 indicating that the subnet is owned by the network entity, a “Yes” in column 306 indicating that the subnet is a routable subnet, a “Yes” in column 308 indicating that the subnet is in at least one routing table, a “No” in column 310 indicating that the subnet is inactive or has orphaned, or unused, IP addresses in its subnet IP address block, a value of “No” in column 312 indicating that there is no ROA using an incorrect ASN, and a “Yes” in column 314 indicating that the correct ASN is specified in an existing ROA.

Referring again to FIG. 1, module 108 can be used to determine an action based on a feature set generated by module 106. Example 300 provides exemplary actions for the feature data sets shown in rows 320 and 332. Module 108 can make a determination that a subnet is not a candidate for an ROA in connection with the feature sets shown in rows 330 and 332. In the case of the feature data set shown in row 332, the network entity is not authorized to create an ROA, since module 106 determined that the subnet is not owned by the network entity. In the case of the feature data set shown in row 330, there is no need for an ROA at this time, since module 106 has determined that the subnet is not a routable subnet and does not exist in any routing tables. If the subnet's subnet information 202 changes at any point, module 106 can update the subnet's feature set and module 108 can use the updated feature set to make an updated action determination. By way of a non-limiting example, the updated action determination can be that the subnet is an ROA candidate if the subnet's updated feature set corresponds to the values shown in row 326.

The action determined by module 108 in connection with the feature set shown in row 324 provides an example in which the subnet may not have been identified in the network entity's inventory database 126. By way of a non-limiting examples, the subnet could be recently created and/or not yet included in the inventory database 126. In such a case, the network entity's inventory database 126 can be updated to include information identifying the subnet as a routable subnet that exists in routing tables and for which an accurate ROA has been created.

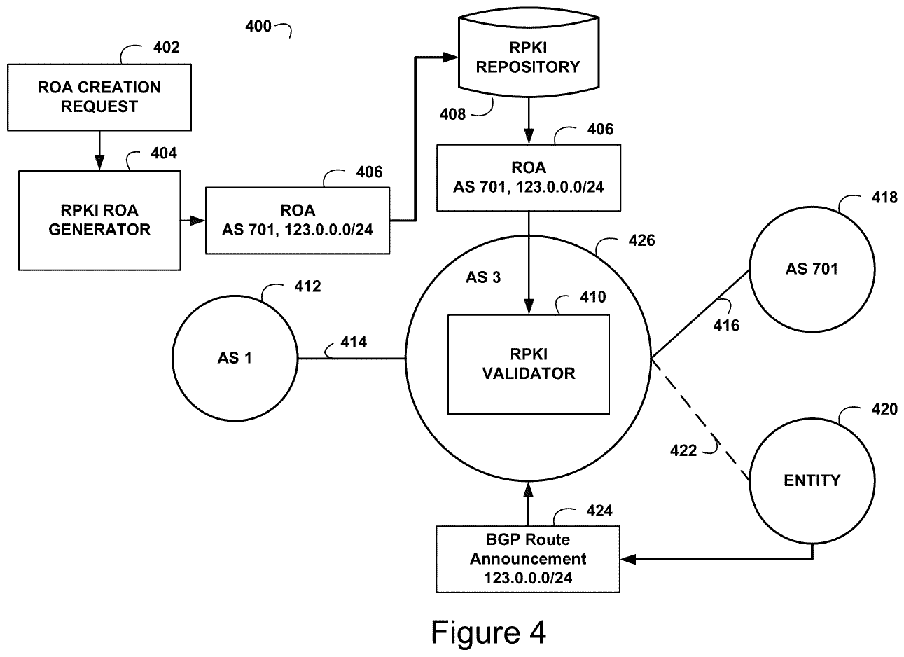

Once the inventory database 126 is synchronized with the current information regarding the subnet, module 106 can make a determination whether or not to forego further analysis of the subnet's subnet information 202. An accurate ROA has been created for the subnet, which can be used to thwart attempts at hijacking the subnet's route(s), as is discussed in more detail in connection with FIG. 4. Module 106 may be used again at some point to analyze the subnet's subnet information 202 in accordance with example 200 to determine whether or not there are any changes in the subnet's subnet information 202 warranting some type of action.

With respect to the feature set shown in row 326 in example 300, module 108 can use feature set shown in columns 304-314 of row 326 to identify a subnet as an ROA candidate and cause an ROA to be created for the subnet. As illustrated by the feature set values in row 326, an ROA has not yet been created for the subnet that is determined to be a routable subnet, that exists in at least one routing table and is an active subnet. The feature data set in row 326 can be used by module 108 to identify the corresponding subnet to be vulnerable to a route hijacking situation—e.g., a current or future route hijacking risk—resulting in traffic being hijacked, or redirected. As is discussed in connection with FIG. 4, an ROA created for the subnet can be used to prohibit current or future hijacking attacks.

As shown in example 300, module 108 can use the feature sets associated with rows 320, 322 and 328 to make a determination to invalidate any existing routes—e.g., routes established by malicious actors attempting to hijack network traffic—and any existing ROA identifying an incorrect ASN. By way of a non-limiting example, module 108 can cause existing routes to be eliminated using an ROA with an ASN set to a reserved ASN, such as zero (0). By way of a further non-limiting example, module 108 can also cause an ROA to be created with the correct ASN.

With reference to FIG. 1, module 108 can cause a determined action to be taken using interface module 110. In accordance with one or more embodiments, module 108 can use module 110 to cause inventory database 126 to be updated to include one or more records containing information identifying a subnet as a routable subnet, that exists in routing tables and for which an accurate ROA has been created. Module 108 can use interface module 110 to generate and output information reporting on actions taken—e.g., ROAs generated—by module 108, information detailing identified vulnerabilities, information identifying recommended actions, etc.

In accordance with one or more disclosed embodiments, module 108 can use interface module 110 to communicate instructions to a Resource Public Key Infrastructure (RPKI) ROA generator. As discussed in connection with FIG. 4, module 108 can instruct an RPKI generator to create a ROA for a subnet. By way of a non-limiting examples, the requested ROA can be used to invalidate existing routes—e.g., routes determined by module 106 to be invalid—using an ASN with a reserved ASN value (e.g., a value of zero). By way of a further non-limiting example, the requested ROA with the correct ASN corresponding to the legitimate owner of the subnet can be used to prohibit a malicious actor from hijacking a network route associated with the subnet and its block of IP addresses.

FIG. 4 provides an exemplary example in which a ROA created in accordance with disclosed embodiments can be used to prohibit network route hijacking. Example 400 includes 3 ASes, AS 412, 426 and 418 with ASNs of 1, 3 and 701, respectively. In example 400, AS 412 is the true owner of the subnet block 123.0.0.0/24. In the example, entity 420 makes BGP route announcement 424 purporting to own subnet block 123.0.0.0/24 in an effort to hijack network traffic away from AS 418 and to its network. Absent ROA 406, AS 426 has no information disputing announcement 424 from entity 420 and acts on announcement 424 causing network traffic received via route 414 from AS 412 to be redirected away from AS 418 to entity 420 via route 422.

In accordance with one or more embodiments, module 108 can instruct an RPKI ROA generator 404, via interface module 110 and ROA creation request 402, to create ROA 406 identifying AS 412 as the owner of the subnet block. Generator 404 can store ROA 406 in RPKI repository 408, where is becomes available to RPKI validator 410. Validator 410 can use ROA 406 to identify AS 418 as the true owner of the subnet block, such that traffic from AS 412 can be correctly routed to AS 418 via route 416. As discussed, although not shown in example 400, module 108 can cause the invalid route created in response to announcement 424 to be invalidated by instructing generator 404 to create a ROA with a reserved ASN value (e.g., a value of zero). Validator 410 can use the ROA with the reserved ASN value to invalidate route 422. By way of a non-limiting example, RPKI ROA generator 404 and RPKI validator 410 can be components of RPKI system 128.

In accordance with one or more embodiments, module 108 can be a machine language model trained using a training data set to determine an action to be performed in response to a feature set generated by module 106 for a subnet using the subnet's subnet information 202. In accordance with one or more embodiments, the training data set can comprise a number of training instances, where each instance comprises a feature set and a label indicating a corresponding action. With reference to FIG. 3, each row in example 300 can be a training data instance with columns 302, 304, 306, 308, 310, 312 and 314 corresponding to features of a feature set and column 316 corresponding to the training instance's label.

In accordance with one or more embodiments, module 106 can generate a feature data set for a subnet using the subnet's subnet information 202 as discussed in connection with FIG. 2. The subnet's feature data set can have a value corresponding to each one of columns 302, 304, 306, 308, 310, 312 and 314. Module 106 can provide the subnet's feature set to module 108 comprising the trained model. The trained model of module 108 can determine at least one action for the subnet as output of the trained model using the subnet's feature set as input to the trained model.

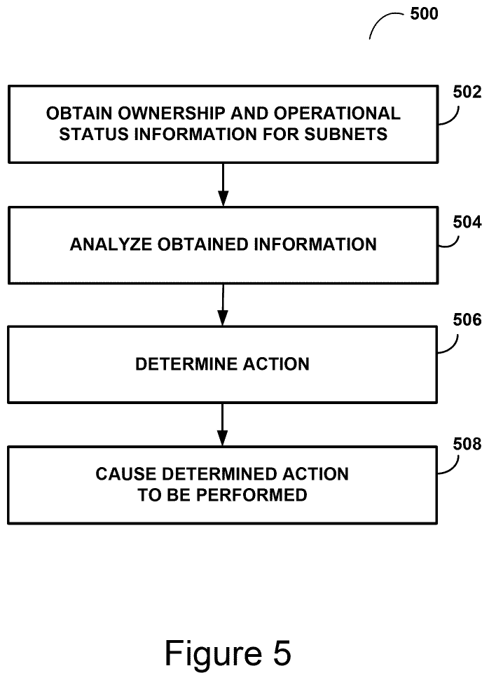

FIG. 5 provides a network route hijacking prohibition process flow in accordance with one or more embodiments of the present disclosure. Process flow 500 can be performed by route protection engine 102. In accordance with one or more embodiments, process flow 500 can be used to automatically and proactively prohibit network route hijacking.

At step 502, ownership and operational status information can be obtained. By way of a non-limiting example, ownership and operational status information can be obtained by subnet information module 104. Operational status information can be obtained using one or more network subnet scanning tools including, without limitation, a network connectivity tool, such as ping, fping, etc., which can be used with subnets 124. In accordance with one or more embodiments, a subnet's operational status information can include information indicating whether the subnet is a routable subnet (e.g., active and reachable), whether the subnet exists in any routing table, whether any IP addresses from a subnet's subnet IP address block are unused, etc.

Ownership information can include information obtained from RIRs 120, geofeed information obtained from geofeeds 122 provided by network entities, such as and without limitation, Internet Service Providers (ISPs), telecommunications network service providers, etc., and subnet inventory information stored in a network entity's inventory database 126.

At step 504, the obtained information can be analyzed. By way of a non-limiting example, step 504 can be performed by subnet information analysis module 106. In accordance with one or more embodiments, module 104 can provide a list of subnets as well as ownership and operational status information for each subnet from the list to module 106. Module 106 can analyze the ownership and operational status information for each respective subnet in the list and generate a set of features for a respective subnet.

By way of a non-limiting example, module 106 can make determinations in accordance with elements 204, 206, 208, 210, 212, 214 and 216 shown in example 200 of FIG. 2 to generate a feature set for a subnet using the subnet's ownership and operational status information, e.g., subnet information 202. By way of a further non-limiting example, a subnet's feature set can comprise features corresponding to columns 304-314 in example 300 of FIG. 3.

At step 506, an action can be determined. By way of a non-limiting example, as discussed herein, action determination module 108 can determine an appropriate action for a subnet using the subnet's feature set generated by module 106. By way of a non-limiting example, module 108 can use a subnet's feature set to determine whether or not the subnet is a ROA candidate. By way some further non-limiting examples, a subnet's feature set can be used by module 108 to determine whether or not to invalidate a subnet's existing routes and/or an existing ROA. By way of a further non-limiting example, module 108 can determine that a network entity's inventory database, such as database 126, should be updated to reflect information about a subnet identified by engine 102. By way of yet another non-limiting example, an action taken by module 108 can include making a recommendation identifying one or more actions to be taken, e.g., by a network security team.

As is described in accordance with one or more disclosed embodiments, module 108 can be a machine model trained to identify an action to take in connection with a subnet given the subnet's feature set determined module 106.

At step 508, a determined action can be caused to be performed. The action that can be caused to be performed can be determined at step 506 and can include without limitation invalidating an existing route, invalidating an existing ROA, creating an ROA, updating subnet information in a network entity's inventory database, identifying one or more of these actions as recommended actions in a report output by engine 102, etc. By way of a non-limiting example, action determination module 108 can cause the action determined at step 506 to be taken.

In accordance with one or more embodiments, module 108 can use module 110 to cause inventory database 126 to be updated to include one or more records contained information identifying a subnet as a routable subnet that exists in routing tables and for which an accurate ROA has been created. Module 108 can use interface module 110 to generate and output information reporting on actions taken—e.g., ROAs generated—by module 108, information detailing identified vulnerabilities, information identifying recommended actions, etc.

As discussed in connection with FIG. 4, module 108 can use interface module 110 to interface with an RPKI ROA generator to instruct the generator to create a ROA for a subnet. By way of a non-limiting examples, the requested ROA can be used to invalidate existing routes—e.g., routes determined by module 106 to be invalid—using a reserved ASN value (e.g., a value of zero). By way of a further non-limiting example, the requested ROA with the correct ASN corresponding to the legitimate owner of the subnet can be used to prohibit a malicious actor from hijacking a network route associated with the subnet and its block of IP addresses.

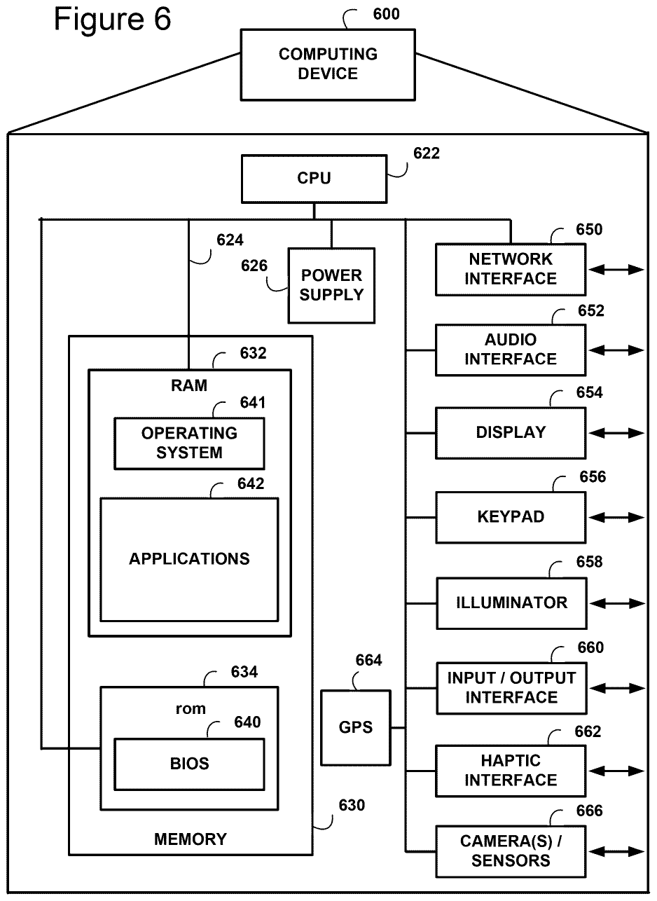

FIG. 6 is a block diagram illustrating a computing device showing an example of a client or server device that can be used to implement functionality described in connection with various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a central processing unit (CPU) 622 in communication with a mass memory 630 via bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666, and power supply 626. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 (e.g., as part of ROM 634) for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to RAM 632 again.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, provide other information that may be employed to determine a physical location of the device, including, for example, a MAC address, IP address, or the like.

The present disclosure has been described with reference to the accompanying drawings, which form a part hereof, and which show, by way of a non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user,” “subscriber,” “consumer,” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
obtaining, by computing device, subnet information, the subnet information comprising subnet ownership and operational status information for a subnet;
generating, by the computing device, a set of features for the subnet based on an analysis of the subnet's ownership and operational status information;
making, by the computing device, at least one route hijack prohibition action determination using the feature set; and
causing, by the computing device, at least one route hijack prohibition action to be taken in accordance with the determination.

2. The method of claim 1, wherein generating a set of features further comprises:
analyzing, by the computing device, the subnet information and determining, based on the analysis, the set of features comprising a feature indicating whether or not a respective network entity owns the subnet, a feature indicating whether or not the subnet is a routable subnet, a feature indicating whether or not the subnet exists in a routing table, a feature indicating whether or not the subnet has an orphaned Internet Protocol (IP) address or is unreachable, a feature indicating whether or not a Route Origin Authorization (ROA) identifying a wrong autonomous system number (ASN) exists, and a feature indicating whether or not a ROA identifying a correct ASN exists.

3. The method of claim 1, wherein making at least one route hijack prohibition action determination further comprises:
determining, by the computing device, to create a ROA as a route hijack prohibition action in response to the feature set indicating that the subnet is owned by a respective network entity, the subnet is a routable subnet, the subnet exists in a routing table and no ROA exists.

4. The method of claim 1, wherein making at least one route hijack prohibition action determination further comprises:
determining, by the computing device, to invalidate each existing route as a route hijack prohibition action.

5. The method of claim 4, wherein determining to invalidate each existing route further comprises:
determining, by the computing device, to invalidate each existing route as a route hijack prohibition action in response to the feature set indicating that the subnet is owned by a respective network entity, the subnet is a routable subnet and the subnet has an orphaned Internet Protocol (IP) address or is unreachable.

6. The method of claim 4, wherein determining to invalidate each existing route further comprises:
determining, by the computing device, to invalidate each existing route as a route hijack prohibition action in response to the feature set indicating that the subnet is owned by a respective network entity, the subnet is a routable subnet, the subnet exists in a routing table and a ROA identifying a wrong ASN exists.

7. The method of claim 4, wherein determining to invalidate each existing route further comprises:
determining, by the computing device, to invalidate each existing route as a route hijack prohibition action in response to the feature set indicating that the subnet is owned by a respective network entity, the subnet is not a routable subnet and the subnet does not exist in a routing table.

8. The method of claim 4, wherein determining to invalidate each existing route comprising determining to create a ROA using a reserved value as ASN.

9. The method of claim 8, further comprising:
using, by the computing device, the ROA using the reserved value as ASN to invalidate any existing ROA.

10. The method of claim 1, making at least one route hijack prohibition action determination further comprises:
determining, by the computing device, to update an inventory database of a respective network entity in response to the feature set indicating that the subnet is owned by a respective network entity, the subnet is a routable subnet, the subnet exists in a routing table and a ROA identifying a correct ASN of an Autonomous System (AS) of the respective network entity exists.

11. The method of claim 1, making at least one route hijack prohibition action determination further comprises:
determining, by the computing device, that the subnet is not a ROA candidate.

12. The method of claim 11, determining that the subnet is not a ROA candidate further comprises:
determining, by the computing device, that the subnet is not a ROA candidate in response to the feature set indicating that the subnet is not owned by a respective network entity.

13. The method of claim 11, determining that the subnet is not a ROA candidate further comprises:
determining, by the computing device, that the subnet is not a ROA candidate in response to the feature set indicating that the subnet is owned by a respective network entity, the subnet is not a routable subnet and the subnet does not exist in a routing table.

14. The method of claim 1, further comprising:
training, by the computing device, a machine model to make the at least one route hijack prohibition action determination, wherein the trained machine model uses the feature set as input to generate model output comprising the at least one route hijack prohibition action determination.

15. A non-transitory computer-readable storage medium tangibly encoded with computer-executable instructions that when executed by a processor associated with a computing device perform a method comprising:
obtaining subnet information, the subnet information comprising subnet ownership and operational status information for a subnet;
generating a set of features for the subnet based on an analysis of the subnet's ownership and operational status information;
making at least one route hijack prohibition action determination using the feature set; and
causing at least one route hijack prohibition action to be taken in accordance with the determination.

16. The non-transitory computer-readable storage medium of claim 15, making at least one route hijack prohibition action determination further comprises:
determining to create a ROA using a reserved value as ASN as a route hijack prohibition action in response to the feature set indicating that the subnet is owned by a respective network entity, the subnet is a routable subnet, the subnet exists in a routing table and no ROA exists.

17. The non-transitory computer-readable storage medium of claim 15, making at least one route hijack prohibition action determination further comprises:
determining, by the computing device, to invalidate each existing route as a route hijack prohibition action in response to:
the feature set indicating that the subnet is owned by a respective network entity, the subnet is a routable subnet and the subnet has an orphaned Internet Protocol (IP) address or is unreachable;
the feature set indicating that the subnet is owned by the respective network entity, the subnet is a routable subnet, the subnet exists in a routing table and a ROA identifying a wrong ASN exists; or
the feature set indicating that the subnet is owned by the respective entity, the subnet is not a routable subnet and the subnet does not exist in a routing table.

18. The non-transitory computer-readable storage medium of claim 15, making at least one route hijack prohibition action determination further comprises:
determining, by the computing device, to update an inventory database of a respective network entity in response to the feature set indicating that the subnet is owned by a respective network entity, the subnet is a routable subnet, the subnet exists in a routing table and a ROA identifying a correct ASN of an Autonomous System (AS) of the respective network entity exists.

19. The non-transitory computer-readable storage medium of claim 15, making at least one route hijack prohibition action determination further comprises:
determining, by the computing device, that the subnet is not a ROA candidate in response to:
the feature set indicating that the subnet is not owned by a respective network entity; or
the feature set indicating that the subnet is owned by the respective network entity, the subnet is not a routable subnet and the subnet does not exist in a routing table.

20. A device comprising:
a processor, configured to:
obtain subnet information, the subnet information comprising subnet ownership and operational status information for a subnet;
generate a set of features for the subnet based on an analysis of the subnet's ownership and operational status information;
make at least one route hijack prohibition action determination using the feature set; and
cause at least one route hijack prohibition action to be taken in accordance with the determination.
